(19) United States
(12) Patent Application Publication
(10) Pub. No.: US 2025/0269808 A1
(43) Pub. Date: Aug. 28, 2025

(54) CENTER CONSOLE BRACKET

(71) Applicant: NISSAN NORTH AMERICA, INC., Franklin, TN (US)

(72) Inventor: Mitzi Vanessa PEÑA ROMERO, Toluca (MX)

(21) Appl. No.: 18/586,071

(22) Filed: Feb. 23, 2024

(51) Int. Cl. B60R 16/02

(52) U.S. Cl. CPC B60R 16/0215

(57) ABSTRACT

A center console bracket includes a center console and a bracket. The center console has a first side wall that at least partially defines a hollow interior of the center console. The bracket has a first portion and a second portion, the first portion being attached to the first side wall within the hollow interior, the second portion being configured to position and retain a first wiring bundle within the hollow interior at a location spaced apart from the first side wall.

### BACKGROUND

### Technical Field

The present disclosure generally relates to center console bracket of a vehicle. More specifically, the present disclosure relates to a center console bracket that supports an electrical connector and connected wiring harness within a hollow interior of the center console.

### Background Information

The center console of current vehicles typically includes digital connectors such as USB ports, charging ports, lighting fixtures and electric switches that operate various devices within the vehicle and/or center console of the vehicle. Typically, there are various wires and connectors that extend into the center console that must be manually connected to the digital connectors, charging ports, lighting fixtures and electric switches.

### SUMMARY

It has been discovered that fixedly attaching a bracket to a side wall within a hollow interior of the center console and fixing a connector with a wiring receptacle to the bracket allows for a quick installation of a wiring harness to the wiring receptacle of the connector during installation of the center console to a floor of a passenger compartment of the vehicle.

In view of the state of the known technology, one aspect of the present disclosure is to provide a center console bracket includes a center console and a bracket. The center console has a first side wall that at least partially defines a hollow interior of the center console. The bracket has a first portion and a second portion, the first portion being attached to the first side wall within the hollow interior, the second portion being configured to position and retain a first wiring bundle within the hollow interior at a location spaced apart from the first side wall.

### BRIEF DESCRIPTION OF THE DRAWINGS

Referring now to the attached drawings which form a part of this original disclosure:

FIG. 1 is a perspective view of a passenger compartment of a vehicle showing a center console attached to a floor of the passenger compartment in accordance with an exemplary embodiment;

FIG. 2 is a perspective view of the center console removed from the passenger compartment in accordance with the exemplary embodiment;

FIG. 3 is a bottom view of the center console showing a bracket attached to a first side wall within a hollow interior of the center console in accordance with the exemplary embodiment;

FIG. 4 is another bottom view of the center console showing the bracket attached to the first side wall within the hollow interior of the center console and with a connector attached to the bracket and a wiring harness connected to the connector in accordance with the exemplary embodiment;

FIG. 5 is a first perspective view of the bracket removed from the center console showing a first portion and a second portion, the second portion of the bracket having a tongue in accordance with the exemplary embodiment;

FIG. 6 is a second perspective view of the bracket showing the first portion, the second portion and the tongue of the second portion in accordance with the exemplary embodiment;

FIG. 7 is a third perspective view of the bracket showing the first portion, the second portion and the tongue of the second portion in accordance with the exemplary embodiment;

FIG. 8 is another perspective view of the bracket with the connector attached to the tongue of the second portion in accordance with the exemplary embodiment;

FIG. 9 is cross-sectional view of the tongue of the second portion and a tongue receiving structure of the connector taken along the line 9-9 in FIG. 8, in accordance with the exemplary embodiment;

FIG. 10 is cross-sectional view of the tongue of the second portion and the tongue receiving structure of the connector taken along the line 10-10 in FIG. 8, in accordance with the exemplary embodiment;

FIG. 11 is a perspective view of the hollow interior of the center console showing the first side wall with the bracket attached thereto and the connector attached to the bracket in accordance with the exemplary embodiment;

FIG. 12 is another perspective view of the hollow interior of the center console looking upward at the first side wall, the bracket attached to the first side wall and the connector attached to the bracket in accordance with the exemplary embodiment;

FIG. 13 is a perspective view of an underside of the center console removed from the passenger compartment of the vehicle showing the wiring harness (also referred to as the second wiring harness) attached to a rear side the connector on the bracket in accordance with the exemplary embodiment;

FIG. 14 is another perspective view of the underside of the center console removed from the passenger compartment of the vehicle showing the wiring harness (the second wiring harness) attached to the rear side of the connector on the bracket and a first wiring harness connected to the connector in accordance with the exemplary embodiment;

FIG. 15 is a side perspective view of the hollow interior of the center console showing the bracket attached to the first side wall, the connector attached to the tongue of the bracket and the wiring harness attached to the connector with a lever of the connector in a locked orientation in accordance with the exemplary embodiment;

FIG. 16 is side view of the hollow interior of the center console showing the bracket attached to the first side wall, the connector attached to the tongue of the bracket and the wiring harness attached to the connector with the lever of the connector in an unlocked orientation in accordance with the exemplary embodiment;

FIG. 17 is a front view of the connector attached to the bracket, showing wiring plug apertures within a wiring receptacle of the connector and showing a gap between a first portion of the bracket and the connector in accordance with the exemplary embodiment;

FIG. 18 is a top view of the connector attached to the bracket, showing the gap between the first portion of the bracket and the connector in accordance with the exemplary embodiment; and

FIG. 19 is a block diagram showing an electronic controller and various components within the vehicle and the center console electronically connected to one another by the wiring harness in accordance with the exemplary embodiment.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

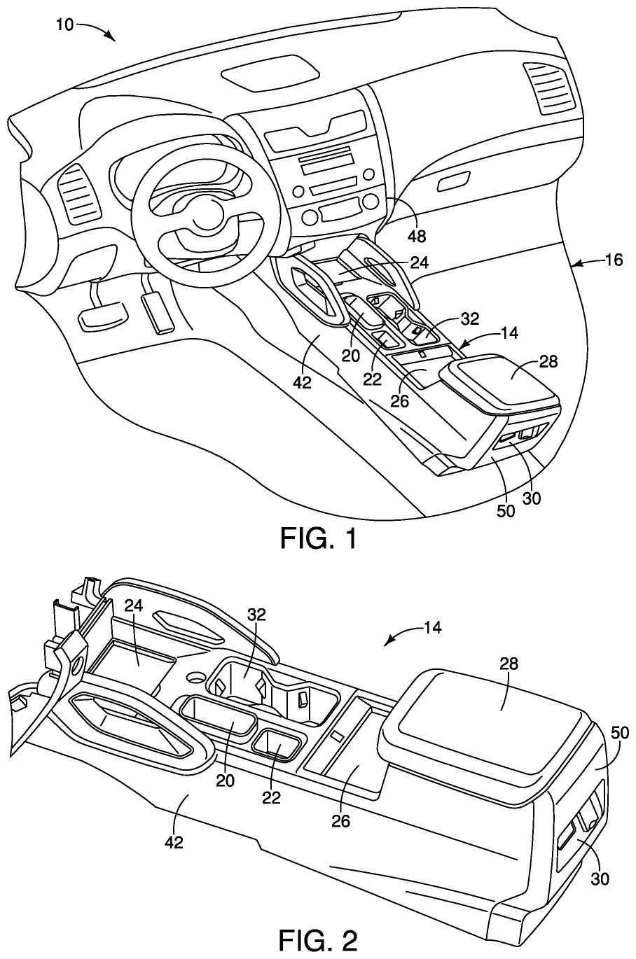

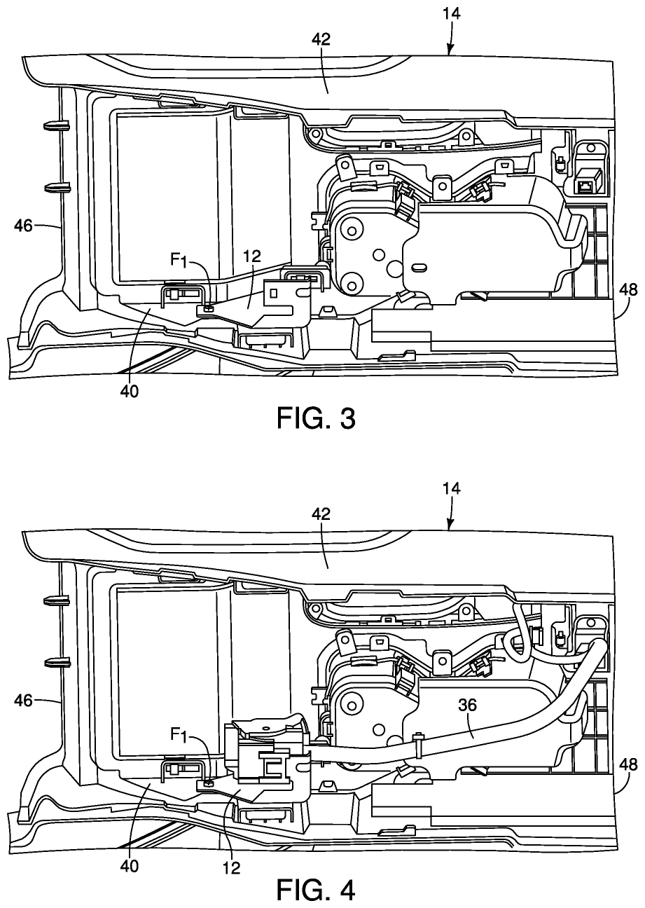

Referring initially to FIGS. 1-4, a vehicle 10 with a center console bracket 12 (FIGS. 3-6) installed within a center console 14 inside a passenger compartment 16 of the vehicle 10 is illustrated in accordance with a first embodiment.

The vehicle 10 can be any vehicle design that can receive a center console such as the center console 14 between front seats (not shown) within the passenger compartment 16 of the vehicle 10.

As shown in FIGS. 1 and 2, the center console 14 is provided with a variety of features. For example, the center console 14 includes a transmission shifter receiving area 20, a switch receiving area 22, a forward storage area 24, a rearward storage area 26, a storage compartment 28, a rear seat control panel area 30 and a cup holder area 32.

The transmission shifter receiving area 20 (hereinafter referred to as a shifter area 20) is dimensioned and shaped to receive a transmission shifter mechanism (not shown). The transmission shifter mechanism can be an electronic device connected to an electronic controller and a transmission of the vehicle 10 via, for example a wiring harness 36 (FIGS. 4 and 12) that provides electronic signals to the controller and the transmission for setting the transmission to Park, Reverse or Forward settings (vehicle operation settings), or can be a mechanical shifter lever mechanically connected to a conventional automatic or standard transmission of the vehicle 10. The switch receiving area 22 is dimensioned and configured to receive a panel of switches, such as window control switches, a door lock switch or other switches (not shown) for controlling specific mechanisms such as operating storage compartment lids or doors, or specific settings for operation of the vehicle 10. The window control switches, the door lock switch and other switches within the panel of switches are conventional switches well known in the art and can also be connected to the wiring harness 36. The switch receiving area 22 can also be provided with outlets for connection of USB cables, chargers or other outlets and/or connection ports (not shown) that are further connected to the wiring harness 36.

The forward storage area 24 and the rearward storage area 26 can be open tray areas that can retain, for example, coins, keys, credit cards or other materials useful to the vehicle operator or passenger seated in the passenger side front seat of the vehicle 10. The storage compartment 28 includes a lid that exposes the storage area and conceals the storage area in a conventional manner. The rear seat control panel area 30 is provided for use by passengers seated behind the front seats (not shown) and rearward of the center console 14. The rear seat control panel area 30 can be provided with environmental controls (heating, air conditioning and fan speed settings) as well as plugs for USB connections or other cables, chargers and the like (not shown) as desired or required and can also be connected to the wiring harness 36. The cup holder area 32 is dimensioned and configured to retain at least two beverage receptacles such as insulated cups, mugs or insulated liquid vessels.

FIGS. 3 and 4 show the underside and hollow interior of the center console 14. As shown, the center console 14 includes a first side wall 40 and a second side wall 42 opposite each other. A hollow interior 44 of the center console 14 is at least partially defined between the first side wall 40 and the second side wall 42. An open front end 46 allows access between an instrument panel 48 and the hollow interior 44 of the center console 14. The rearward end 50 of the center console 14 has an end wall that includes the rear seat control panel area 30.

As shown in FIGS. 3 and 4, the center console bracket 12 (hereinafter the bracket 12) is attached to the first side wall 40 via, for example, Fasteners F1. As shown in FIG. 4 the wiring harness 36 includes a connector 50 that attaches to the bracket 12, as described in greater detail below.

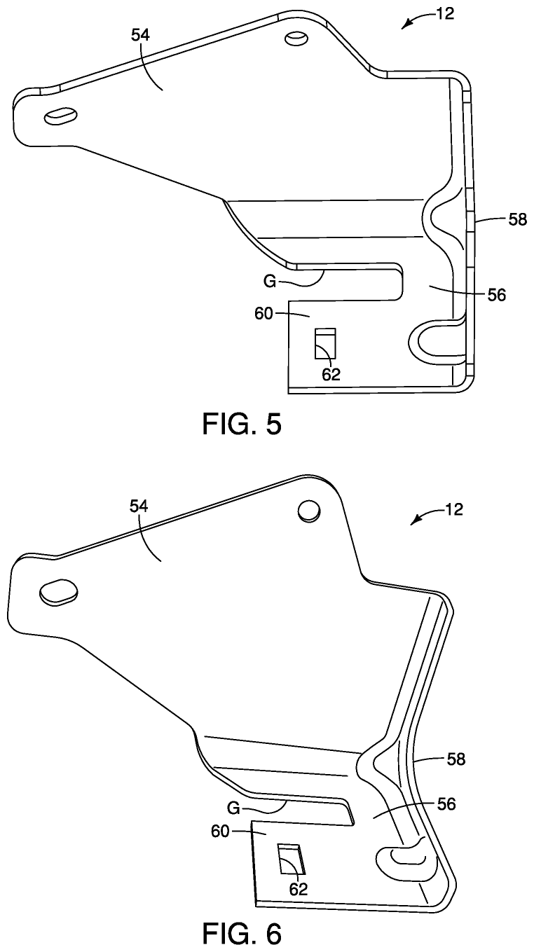

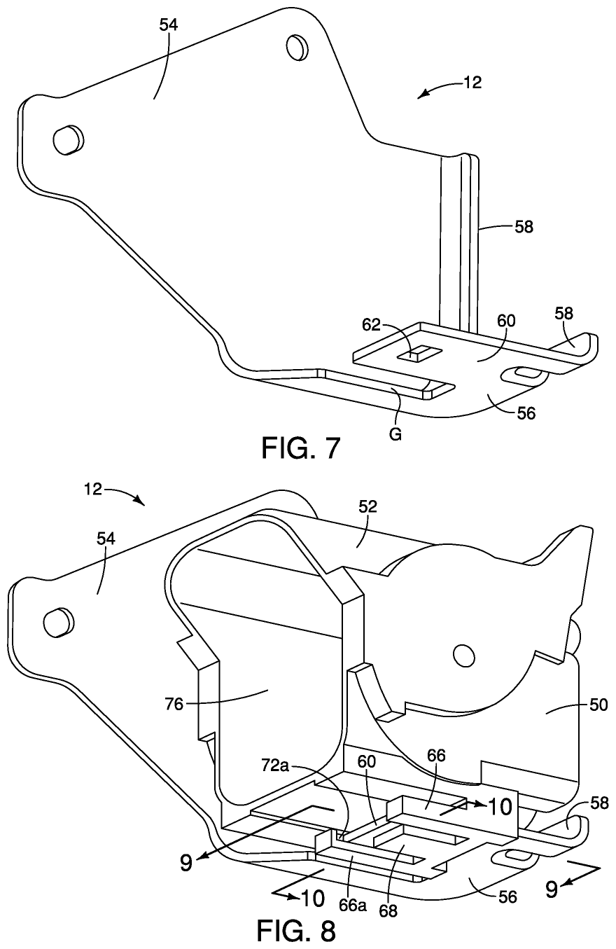

As shown in FIGS. 5, 6 and 7, the bracket 12 basically includes a first portion 54, a second portion 56 and a stiffening portion 58. As shown in FIGS. 3 and 4, the first portion 54 is attached to the first side wall 40 within the hollow interior 44. The second portion 56 is configured to position and retain the wiring harness 36 within the hollow interior 44 at a location spaced apart from the first side wall 40. The second portion 56 is generally perpendicular (+/−5 degrees) to the first portion 54. The second portion 56 extends away from the first portion 54 and the first side wall 40 when the bracket 12 is installed to the first side wall 40. The stiffening portion 58 extends along adjacent edges of the first portion 54 and the second portion 56 with the stiffening portion 58 extending in a direction perpendicular to both the first portion 54 and the second portion 56.

The second portion 56 of the bracket includes a gap G that extends in a direction parallel to the first side wall 40. Adjacent to the gap G, the second portion 56 includes a tongue 60 that also extends in a direction parallel to the first side wall 40. The tongue 60 includes an opening 62. The tongue 60 is also referred to herein below as the tongue structure 60.

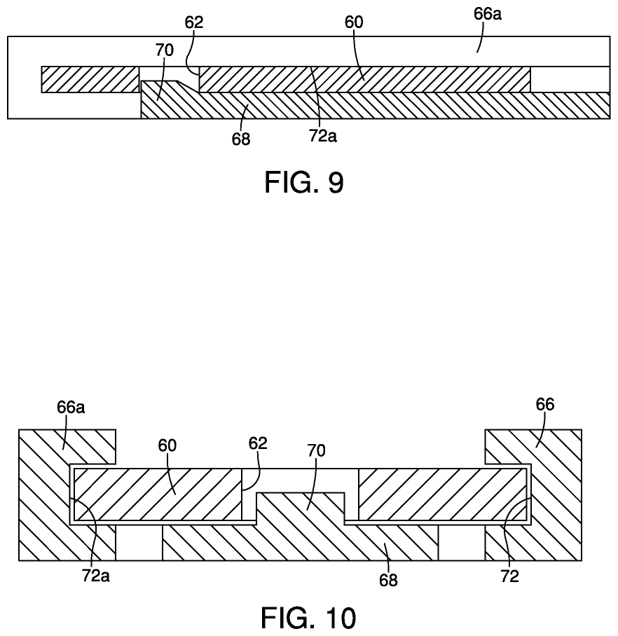

As shown in FIGS. 8-10 and 12, the connector 50 has a housing 52 that includes tongue receiving structures 66 and 66a, a locking protrusion 68 and a snap-fitting projection 70 (FIGS. 9 and 10 only). The tongue receiving structure 66 includes a groove 72 and the tongue receiving structure 66a includes a groove 72a. The grooves 72 and 72a are dimensioned such that the tongue 60 slides into and along the grooves 72 and 72a until the snap-fitting project 70 moves into the opening 62, locking the connector 50 to the second portion 56 of the bracket 12. The tongue structure 60 and the tongue receiving structures 66 and 66a extend in directions that are generally parallel to the first portion 54 of the bracket 12.

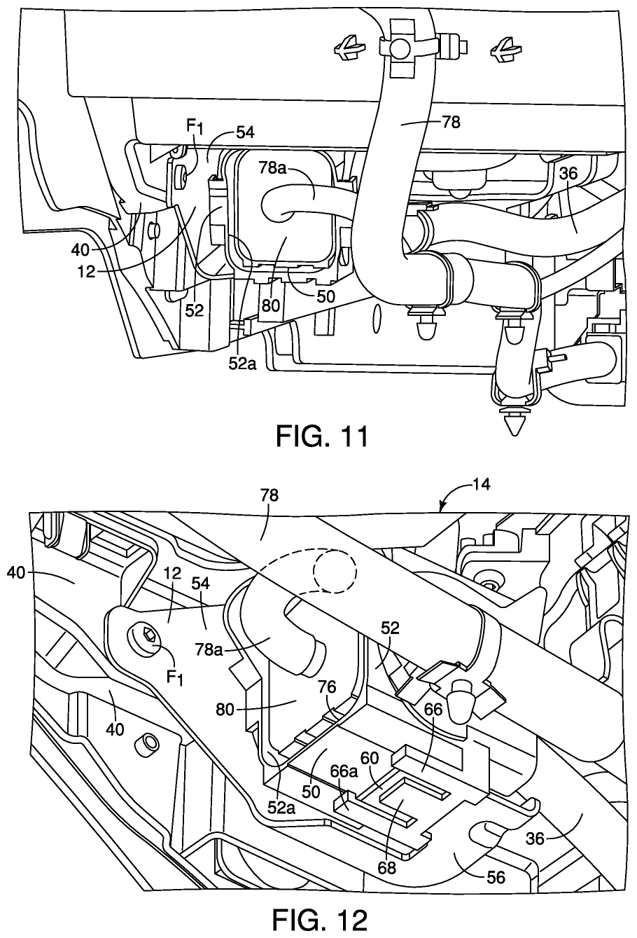

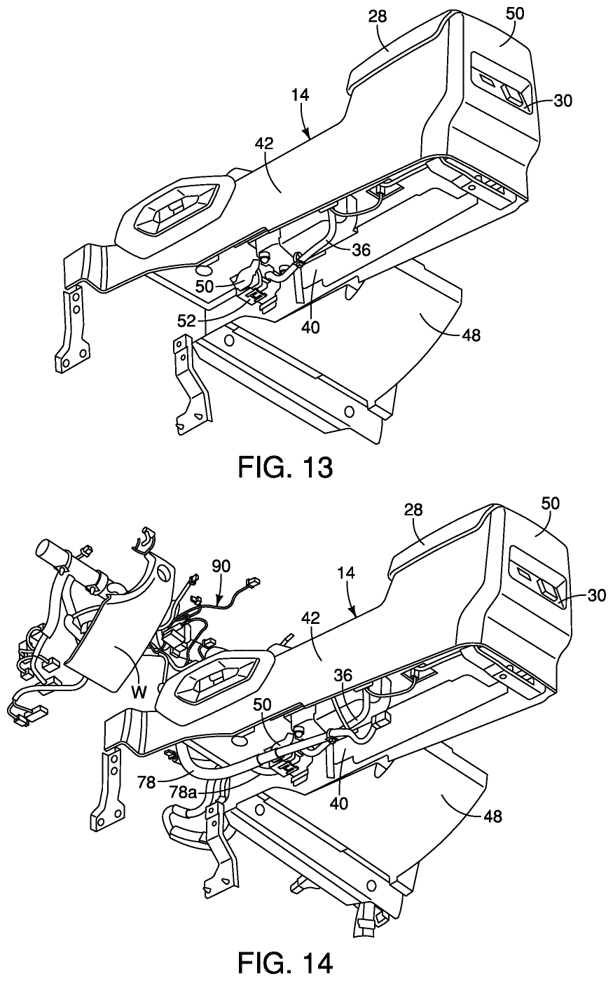

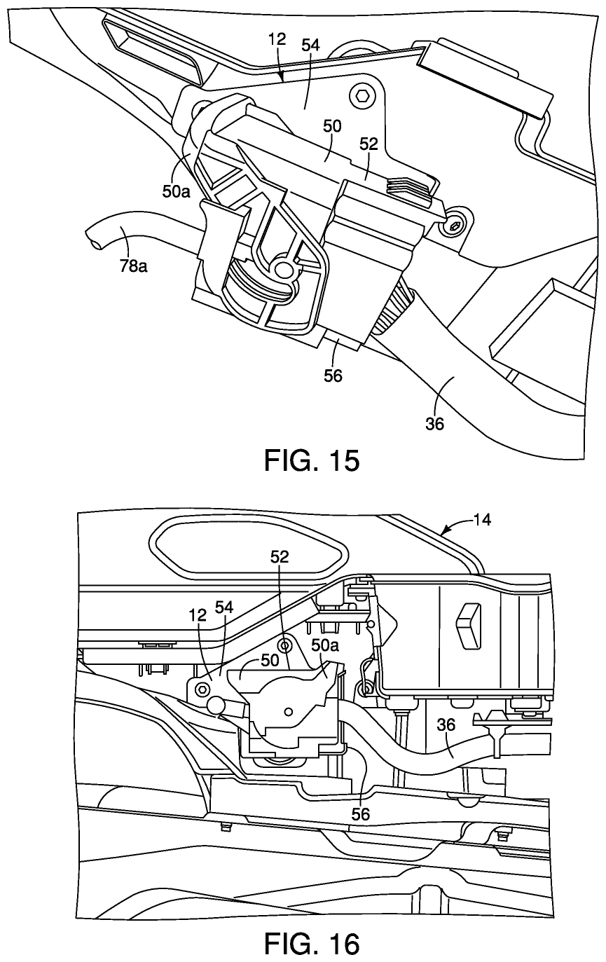

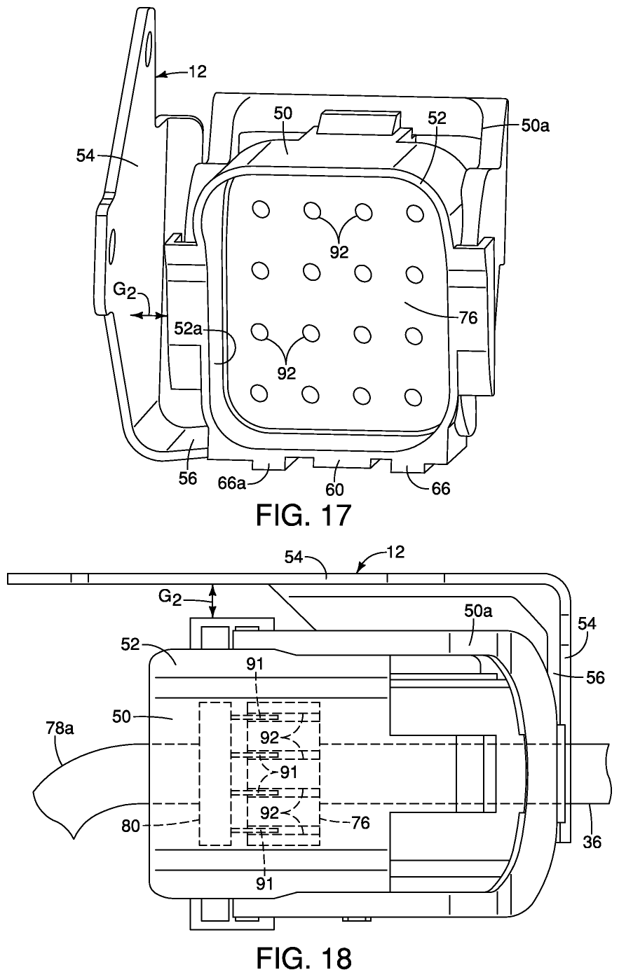

As shown in FIGS. 11, 12 and 17, the housing 52 of the connector 50 also defines an opening 52a that exposes a wiring receptacle 76 (FIG. 17) at a forward end of the housing 52. The connector 50 is configured and dimensioned to receive and support an end connector 80 or plug 80 that is attached to wires of a first wiring harness 78. When the plug 80 is inserted into the wiring receptacle 76, pins 91 connected to corresponding wires of the first wiring harness 78 are electrically connected to corresponding wires within receptacle openings 92 within the wiring receptacle 76.

The first wiring harness 78 includes a wiring branch 78a that includes the plug 80, as shown in FIG. 12. A rear side of the connector 50 is further connected to the wiring harness 36 (herein after the second wiring harness 36).

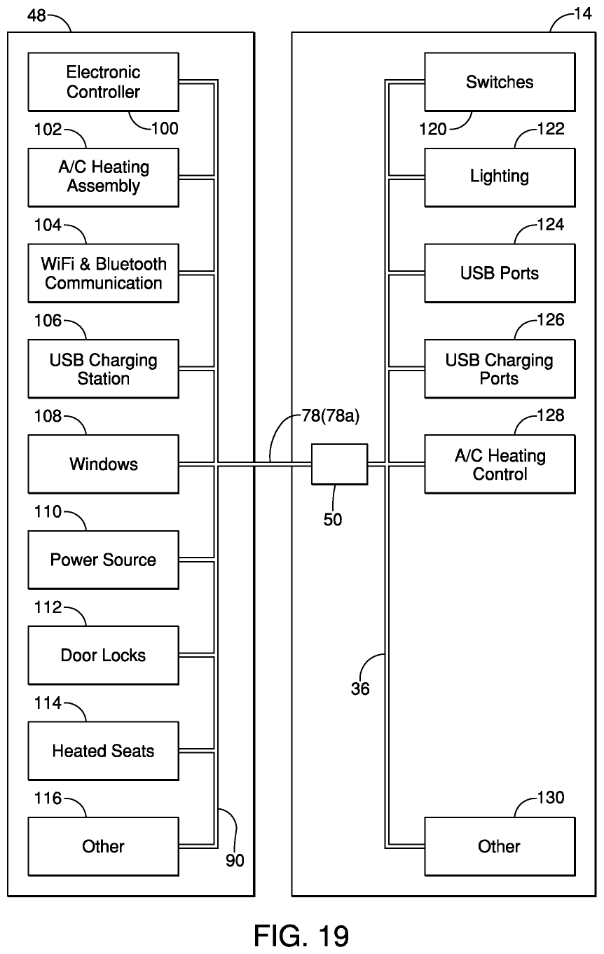

As shown in FIG. 14, when installed to the connector 50, the first wiring harness 78 includes a plurality of wires there in that extend from beneath the center console 14 where the first wiring harness splits off into a plurality of wiring bundles in order to connect to corresponding bundles of wirings 90 concealed behind and beneath the instrument panel 48. As shown in FIGS. 14 and 19, the bundles of wires 90 connect to various devices, including an electronic controller 100, an A/C & heating assembly 102, WiFi communication controller 104, USB charging power source 106, electric windows 108, a power source 110, door locks 112, heated seats 114 as well as other units and devices 116 of the vehicle 10. The first wiring harness 78 and branch 78a connect via the connector 50 to the various switches 120, lighting units 122, USB ports 124, USB charging ports 126 and A/C & heating controls 128 as well as other units 130 located on or within the center console 14.

The inclusion of the bracket 12 and the connector 50 within the hollow interior of center console 14 makes it possible to pre-wire many, if not all, of the light 122, the USB ports 124, USB charging ports 126 and A/C heating controls 128, as well as other 130 electronic features that can be installed to the center console 14. The pre-wiring includes connecting the wires and wire bundles of to the second wiring harness 36 to the above features on or within the center console 14. The second wiring harness 36 is connected to the connector 50. The connector 50 and the second wiring harness 36 are preinstalled to the bracket 12 prior to installation of the center console 14 to the floor of the passenger compartment 16. Further, the pre-wiring can occur prior to installing the center console 14 within the passenger compartment 16.

As the center console 14 (with the bracket 12, connector 50 and second wiring harness 36 pre-installed) is installed to the floor of the passenger compartment 16, the plug 80 of the wiring harness branch 78a of the first wiring harness 78 can be installed to the wiring receptacle 76 of the connector 50. Further wires of the first wiring harness 78 can also be connected to pre-determined electrical features of the center console 14, and/or the distal end portion (not shown) of the first wiring harness 78 can be fed into a tunnel (not shown) that extends beneath flooring (for example, carpeting) and the rear seat (not shown) of the vehicle 10 to provide power and control wiring to features in a rearward area of the vehicle 10.

The controller 100 preferably includes a microcomputer with vehicle systems control programs that control, for example, the A/C heating assembly 102, determines and implements connection of USB cables plugged into one or more of the USB ports to the appropriate vehicle system (for example, an audio system of the vehicle 10). The controller 100 can also include other conventional components such as an input interface circuit, an output interface circuit, and storage devices such as a ROM (Read Only Memory) device and a RAM (Random Access Memory) device.

The various other depicted features, such as the instrument panel 48, are conventional components that are well known in the art. Since these features are well known in the art, these structures will not be discussed or illustrated in detail herein. Rather, it will be apparent to those skilled in the art from this disclosure that the components can be any type of structure and/or programming that can be used to carry out the present invention.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment, the following directional terms “forward”, “rearward”, “above”, “downward”, “vertical”, “horizontal”, “below” and “transverse” as well as any other similar directional terms refer to those directions of a vehicle equipped with the center console bracket. Accordingly, these terms, as utilized to describe the present invention should be interpreted relative to a vehicle equipped with the center console bracket.

The term “detect” as used herein to describe an operation or function carried out by a component, a section, a device or the like includes a component, a section, a device or the like that does not require physical detection, but rather includes determining, measuring, modeling, predicting or computing or the like to carry out the operation or function.

The term “configured” as used herein to describe a component, section or part of a device includes hardware and/or software that is constructed and/or programmed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such features. Thus, the foregoing descriptions of the embodiments according to the present invention are provided for illustration only, and not for the purpose of limiting the invention as defined by the appended claims and their equivalents.

What is claimed is:

1. A center console bracket, comprising:
a center console having a first side wall that at least partially defines a hollow interior of the center console; and
a bracket having a first portion and a second portion, the first portion being attached to the first side wall within the hollow interior, the second portion being configured to position and retain a first wiring bundle within the hollow interior at a location spaced apart from the first side wall.

2. The center console bracket according to claim 1, further comprising:
a connector attached to the second portion of the bracket, the connector being connected to and supporting the first wiring bundle.

3. The center console bracket according to claim 2, wherein
the connector is connected to a second wiring harness that extends rearward within the hollow interior of the center console, the second wiring harness including wiring that connects to components installed to the center console.

4. The center console bracket according to claim 3, wherein
the connector having a tongue receiving structure, and
the second portion of the bracket includes a tongue structure configured such that with the tongue receiving structure fitted on to the tongue structure, the connector is retained on the tongue structure.

5. The center console bracket according to claim 4, wherein
the connector includes a wiring receptacle configured and dimensioned to receive and support an end connector of the first wiring harness.

6. The center console bracket according to claim 1, wherein
the first portion and the second portion of the bracket are perpendicular to one another.

7. The center console bracket according to claim 6, wherein
the connector has a tongue receiving structure, and
the second portion of the bracket includes a tongue structure configured such that with the tongue receiving structure fitted on to the tongue structure, the connector is retained on the tongue structure.

8. The center console bracket according to claim 7, wherein
the tongue structure extends in a direction parallel to the first portion of the bracket.

9. The center console bracket according to claim 1, wherein
the connector has a forward end configured to receive and retain an end connector of the first wiring bundle.

10. A center console bracket, comprising:
a center console having first side wall with the center console having a hollow interior at least partially defined by the first side wall;
a bracket having a first portion and a second portion, the first portion being attached to the first side wall within the hollow interior, the second portion extending away from the first portion and the first side wall; and
a wiring harness having a portion thereof that extends within the hollow interior of the center console and the second portion being configured and dimensioned to position and retain the wiring harness within the hollow interior at a location spaced apart from the first side wall.

11. The center console bracket according to claim 10, further comprising:
a connector directly attached to the second portion of the bracket, the connector being connected to and supporting the first wiring bundle.

12. The center console bracket according to claim 11, wherein
the connector is connected to a second wiring harness that extends rearward within the hollow interior of the center console, the second wiring harness including wiring that connects to components installed to the center console.

13. The center console bracket according to claim 12, wherein
the connector having a tongue receiving structure, and
the second portion of the bracket includes a tongue structure configured such that with the tongue receiving structure fitted on to the tongue structure, the connector is retained on the tongue structure.

14. The center console bracket according to claim 13, wherein
the connector includes a wiring receptacle configured and dimensioned to receive and support an end connector of the first wiring harness.

15. The center console bracket according to claim 10, wherein
the first portion and the second portion of the bracket are perpendicular to one another.

16. The center console bracket according to claim 15, wherein
the connector has a tongue receiving structure, and
the second portion of the bracket includes a tongue structure configured such that with the tongue receiving structure fitted on to the tongue structure the connector is retained on the tongue structure.

17. The center console bracket according to claim 16, wherein
the tongue structure extends in a direction parallel to the first portion of the bracket.

18. The center console bracket according to claim 10, wherein
the connector has a forward end configured to receive and retain an end connector of the first wiring bundle.
